(19) United States
(12) Patent Application Publication
(10) Pub. No.: US 2006/0174487 A1
(43) Pub. Date: Aug. 10, 2006

(54) Hair trimmer

(75) Inventors: Matthew L. Andis, Racine, WI (US); Richard J. Tringali, Racine, WI (US); Robert E. Derby, Racine, WI (US); Andrew A. Skuhra, Racine, WI (US)

Correspondence Address: MICHAEL BEST & FRIEDRICH, LLP, 100 E WISCONSIN AVENUE, MILWAUKEE, WI, 53202, US

(73) Assignee: Andis Company, Racine, WI (US)

(21) Appl. No.: 11/389,889

(22) Filed: Mar. 27, 2006

Related U.S. Application Data
(63) Continuation-in-part of application No. 11/231,013, filed on Sep. 20, 2005.
Application No. 11/231,013 is a continuation of application No. 10/285,390, filed on Oct. 31, 2002, now Pat. No. 6,948,248.

(51) Int. Cl. B26B 19/00

(52) U.S. Cl. 30/34.05; 30/195

(57) ABSTRACT

A hair trimmer having an ion emitter assembly that emits ions for use in hair care processes. The hair trimmer includes a body portion having a cutting end, the body portion defining a cavity and an opening communicating with the cavity wherein the opening is separate from the cutting end. The hair trimmer includes a blade set mounted adjacent the cutting end, and a comb coupled to the cutting end of the body portion wherein the blade set is at least partially disposed within the comb. The ion emitter assembly is at least partially mounted within the cavity, wherein ions emitted from the ion emitter assembly flow through the opening and toward the cutting end and the comb.

### CROSS-REFERENCE TO RELATED APPLICATION

This application is a continuation-in-part of U.S. patent application Ser. No. 11/231,013, entitled “HAIR TRIMMER”, filed Sep. 20, 2005 by Matthew L. Andis, Richard J. Tringali, and Robert E. Derby, which is a continuation of U.S. patent application Ser. No. 10/285,390, entitled “HAIR TRIMMER”, filed Oct. 31, 2002 and issued as U.S. Pat. No. 6,948,248 on Sep. 27, 2005, by Matthew L. Andis, Richard J. Tringali, and Robert E. Derby.

### BACKGROUND OF THE INVENTION

The invention relates to methods and apparatus for trimming hair.

Various methods and apparatus for trimming hair have been used in the past. Nevertheless, a new method and apparatus for trimming hair that provides enhanced hair care results would be welcomed by those that utilize hair trimmers.

### SUMMARY OF THE INVENTION

In one embodiment, the invention provides a hair trimmer including a body portion having a cutting end, the body portion defining a cavity and an opening communicating with the cavity wherein the opening is separate from the cutting end. The hair trimmer also includes a blade set mounted adjacent the cutting end and a comb coupled to the cutting end of the body portion, wherein the blade set is at least partially disposed within the comb. An ion emitter assembly is at least partially mounted within the cavity, wherein ions emitted from the ion emitter assembly flow through the opening and toward the cutting end and the comb.

In another embodiment, the invention provides a hair trimmer configured to trim hair and reduce a static charge of the hair as the hair is trimmed. The hair trimmer includes a body portion having a cutting end. The body portion defines an inner cavity and an opening communicating with the cavity wherein the opening is separate from the cutting end and faces generally toward the cutting end. The hair trimmer includes a blade set mounted adjacent the cutting end and a comb coupled to the cutting end of the body portion wherein the blade set is at least partially disposed within the comb. An ion emitting assembly is at least partially mounted within the inner cavity. The ion emitting assembly includes an ionizer adapted to receive an ionizer input power and an electrode positioned adjacent the opening. The electrode is electrically coupled to and adapted to receive an output power from the ionizer to emit ions, wherein ions emitted from the electrode pass through the opening and toward the cutting end and the comb.

Further objects of the present invention together with the organization and manner of operation thereof, will become apparent from the following detailed description of the invention when taken in conjunction with the accompanying drawings wherein like elements have like numerals throughout the drawings.

### BRIEF DESCRIPTION OF THE DRAWINGS

FIG. 1 is a perspective view of a hair trimmer of the present invention.

FIG. 2 is a perspective view of another hair trimmer of the present invention.

FIG. 3 is a perspective view of the hair trimmer of FIG. 2 with a portion cut away.

FIG. 4 is a top view of the hair trimmer of FIG. 2 with a portion cut away.

FIG. 5 is a side view of the hair trimmer of FIG. 2 with a portion cut away.

FIG. 6 is a side view similar to FIG. 5 showing an alternative construction of the hair trimmer of FIG. 2.

FIG. 7 is a perspective view of another hair trimmer of the present invention.

FIG. 8 is a side view of the hair trimmer of FIG. 7 with a portion cut away.

FIG. 9 is a perspective view of a hair trimmer of the present invention, including a removable comb and a power switch for an ion emitter assembly.

FIG. 10 is an end view of the hair trimmer of FIG. 9 with the comb removed.

FIG. 10A is an enlarged end view of the hair trimmer of FIG. 10 with a screen removed.

FIG. 11 is a sectional view of the hair trimmer of FIG. 9 taken along line 11-11.

FIG. 12 is a perspective view of the comb of the hair trimmer shown in FIG. 9.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting.

### DETAILED DESCRIPTION

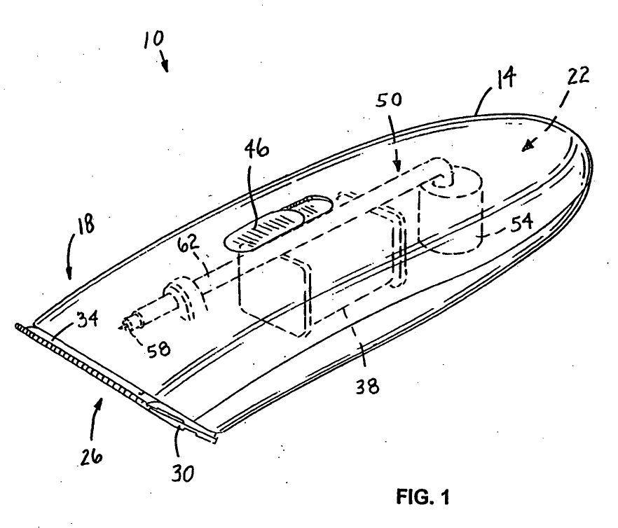

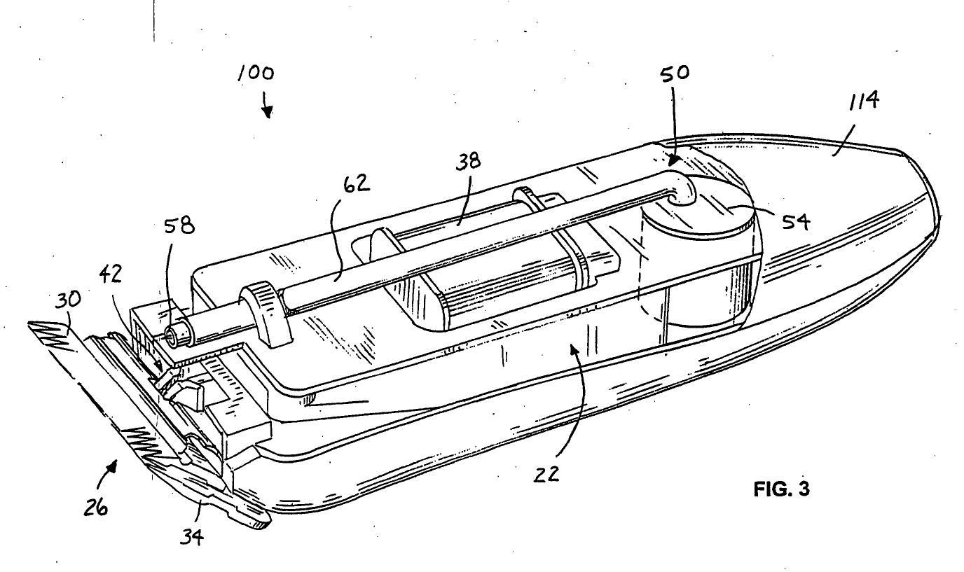

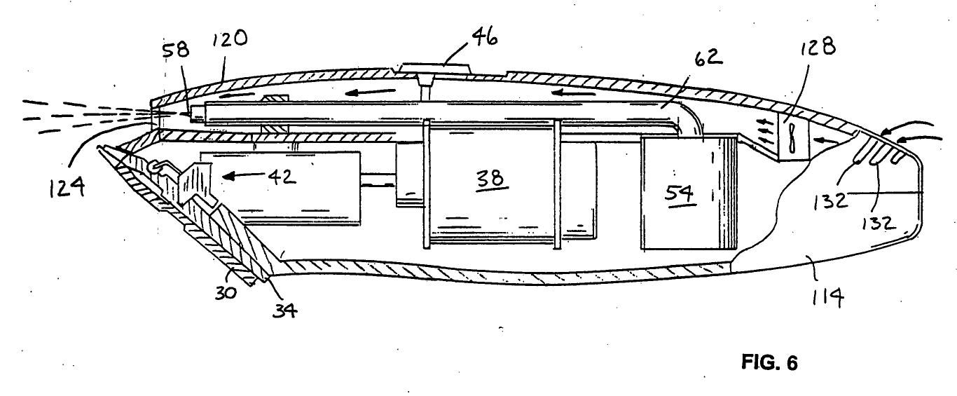

FIG. 1 illustrates a hair trimmer or clipper 10 of the present invention. The hair trimmer 10 includes a hollow, elongated body portion 14 having a cutting end 18 and defining an inner cavity 22. The elongated body 14 supports a blade set 26 on the cutting end 18. The blade set 26 includes a fixed blade 30 mounted on the body portion 14 and a reciprocating blade 34 biased against and moveable with respect to the fixed blade 30 by a drive mechanism 42 (FIGS. 3 and 5). An electric motor or actuator 38 is mounted in the inner cavity 22 and is drivingly connected to the blade set 26 by the drive mechanism 42. The electric motor 38 effects reciprocation of the reciprocating blade 34 with respect to the fixed blade 30 in response to actuation of the motor 38. A user actuates the motor 38 using a power switch 46 provided on the body portion 14. The switch 46 is configured to interrupt the flow of electrical power from a power supply to the electric motor 38. The electrical power may include an alternating current (AC) power provided via a corded plug electrically coupled to a wall outlet and/or a direct current (DC) power provided by a battery (e.g., a rechargeable battery disposed in the cavity 22). Hair trimmers powered by AC and/or DC power are generally known in the art and, accordingly, are not discussed further herein. As the hair trimmer 10 is guided through a person's hair, the reciprocating motion of the blade set 26 cuts the person's hair. A number of suitable blades sets, motors, and driving arrangements are known. It should be appreciated that hair trimmers having other types of blade sets, motors, and/or driving arrangements would be suitable for use in combination with the present invention.

The hair trimmer 10 includes an ion emitting assembly 50 having an ionizer 54, an ion emitting electrode 58, and an ion lead 62 that electrically couples the ionizer 54 and the electrode 58. In some embodiments, as illustrated in FIG. 1, the ionizer 38 is mounted in the cavity 22 and the electrode 42 is mounted near the cutting end 18. In other embodiments, the components 54, 58, and 62 of the ionizer 38 may be alternatively positioned (e.g., the components 54, 58, and 62, or portions thereof, may be mounted alternatively inside the cavity, outside the cavity, or a combination thereof).

For operation, the ionizer 54 receives an ionizer input power from a power source. Similar to the motor 38, the ionizer input power may include an AC power and/or a DC power. In some embodiments, the input power of the motor 38 may be substantially similar to the ionizer input power. In one embodiment, the ionizer input power is provided to the ionizer 54 when the user actuates the switch 46 to an ON position. In another embodiment, a separate ionizer switch (not shown) is provided on the body portion 14. The ionizer switch is configured to interrupt the flow of electrical power (i.e., the ionizer input power) from a power supply to the ionizer 54. Utilization of a separate ionizer switch allows a user to control the ion emitting assembly 50 independent of the motor 38.

The ionizer 54 utilizes the ionizer input power to generate an ionizer output power. In most embodiments, the ionizer output power is a high voltage, low current power. In one embodiment, the ionizer input power is a 120 volt AC power, which is the standard residential electrical service provided in the United States, and the ionizer output power includes a voltage between approximately negative 3.3 kilo-volts DC and negative 4.8 kilo-volts DC and a current of approximately 50 micro-amps. In other embodiments, alternative values of ionizer input and output powers are possible depending on the specific configuration of the ionizer 54.

The electrode 58 receives the ionizer output voltage from the ionizer 54 via the ion lead 62 and emits ions. The length of the ion lead 62 may vary based on location of the electrode 58 with respect to the ionizer 54. In some embodiments, the need for the ion lead 62 may be obviated. In the illustrated embodiment, the ions emitted from the electrode 58 are negative ions. The emitted negative ions are utilized to facilitate hair care process as discussed further below. While the illustrated embodiments are described as emitting negative ions for use in hair care processes, positive ions may be emitted in place of, or in combination with, the negative ions. Additionally, although the illustrated electrode 58 is a needle electrode, other embodiments of the electrode 58 may include alternative shapes (e.g., a plate electrode) and sizes.

In one embodiment, the ion emitting assembly 54 includes ion generator model number SW750H-8 provided by Seawise Industrial Ltd. of Kowloon Hong Kong. The Seawise ion generator utilizes an input power having a voltage of 120 volts AC to generate an output power having a maximum negative voltage of approximately negative 7.5 kilo-volts DC and current of approximately 50 micro-amps. The Seawise ion generator generates negative ions. In other embodiments, the ion emitting assembly 54 may include other configurations of ion generators.

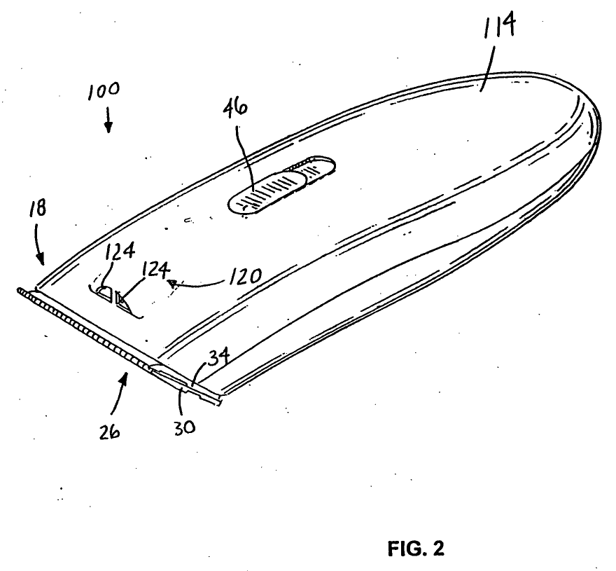

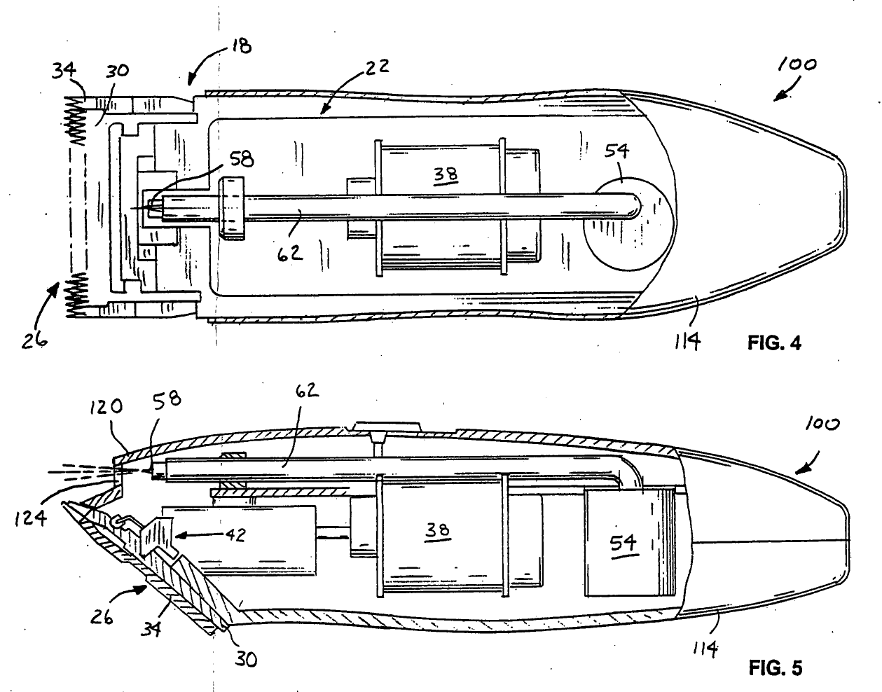

FIGS. 2-5 illustrate a hair trimmer 100. The hair trimmer 100 is similar to the hair trimmer 10 and like parts are identified using the same reference numerals. The hair trimmer 100 includes a body portion 114 that includes a shroud portion 120. The shroud portion 120 defines openings 124 that communicate with the inner cavity 22 and open toward the cutting end 18. The shroud portion 120 substantially surrounds the electrode 58 such that ions emitted from the electrode 58 pass through the openings 124 and flow generally toward the cutting end 18.

In one embodiment, the ions emitted by the electrode 58 of the hair trimmer 100 substantially reduce or eliminate static electricity on a person's hair as the hair trimmer 100 is used to trim the person's hair. Static electricity may cause a person's hair to stand on end, making the hair difficult to manage as well as aesthetically displeasing. Static electricity may be generated due to the motion of a hair trimmer and/or combs and brushes through a person's hair. Additionally, static electricity may be alternatively generated on a person's hair.

As a person's hair is trimmed, the ions emitted from the electrode 58 may be passively and/or actively moved to a person's hair.

In one embodiment, the ions are passively moved to the person's hair via an “ionic wind”. As the ions are emitted from the electrode 58, the emitted ions move outward away from the electrode 58. The continuous movement of ions away from the electrode is known as an “ionic wind”. In some embodiments, the emitted ions are attracted to an object (e.g., the person's hair) with an opposite polarity. The emitted ions travel through electric field lines away from the electrode 58 to the object. The ions then act to neutralize the opposite charge on the object. Neutralization of the opposite charge thereby reduces or eliminates static electricity. In other embodiments, the emitted ions are concentrated on an object, thereby creating a net positive or negative charge on the object.

In another embodiment, as shown in FIG. 6, the hair trimmer 100 may include a fan 128 (schematically represented). The fan 128 is utilized to actively move the emitted ions away from the electrode 58 towards the person's hair. The fan 128 draws air in through air vents 132 and moves air through the cavity 22 past the electrode 58 and out the openings 124 in the shroud 120. The movement of air is represented in FIG. 6 with arrows. The cavity 22 may include structure to direct the flow of air through specific parts thereof. The fan 128 assists the passive movement of ions from the electrode 58. The ions are attracted to the person's hair for neutralization of the static electricity, or concentrated on an object resulting in a positive or negative charge on the object, in a similar fashion as discussed above with respect to the passive movement.

In one embodiment, the ions emitted by the electrode 58 of the hair trimmer 100 are utilize to charge the blade set 26 for attraction of the trimmed hairs 128. As the ions are emitted from the electrode 58, the emitted ions collect on the metal blade set 26, thereby charging the blade set 26. The charged blade set 26 attracts objects with an opposite polarity (e.g., the hairs 136 trimmed from a person's hair). As the hairs 136 are trimmed, they are attracted to the blade set 26, thereby reducing or eliminating the hairs 136 from falling on the floor or the person. The degree of charge on the blade set 26 may be controlled to optimize the amount of hair 136 that is attracted. In other embodiments, the blade set 26 is charged to a degree that repels hair from collecting on the blade set 26 but does not interfere with the hair trimming process.

In one embodiment, the ions emitted by the electrode 58 may substantially reduce or eliminate static electricity on a person's hair and charge the blade set 26 for attraction of the trimmed hairs 128. In other embodiments, portions of the blade set 26 are made of an insulating material (e.g., ceramic) to reduce the attraction of the hairs 136.

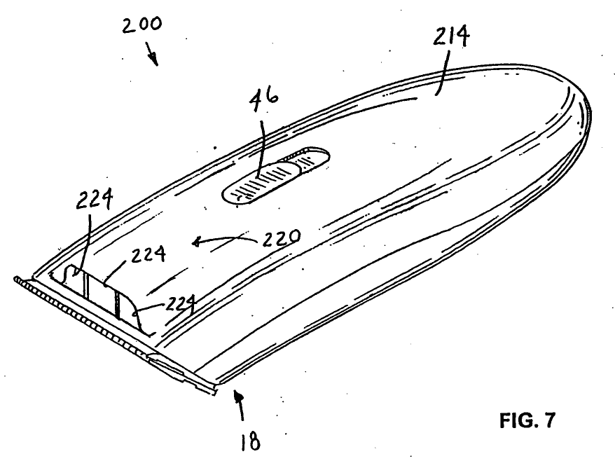

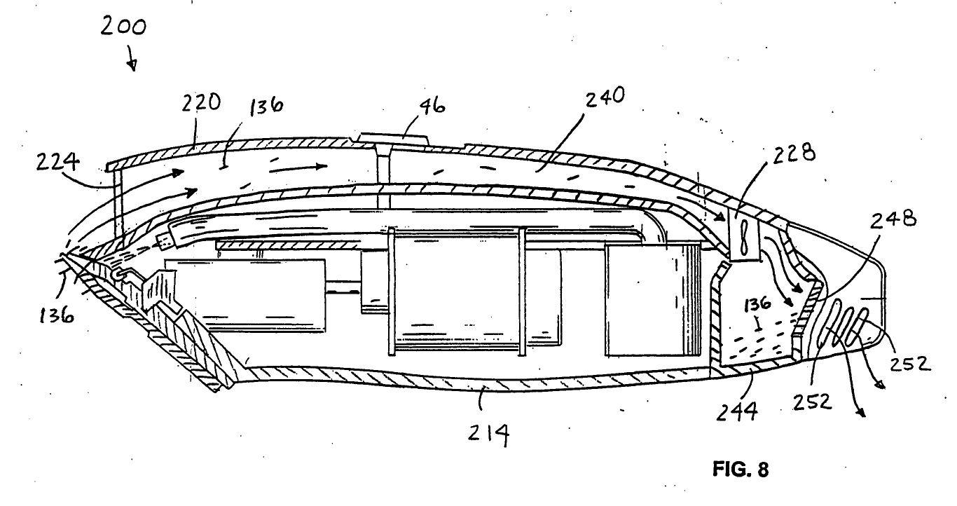

FIGS. 7-8 illustrate a hair trimmer 200. The hair trimmer 200 is similar to the hair trimmers 10 and 100 and like parts are identified using the same reference numerals. The hair trimmer 200 includes a body portion 214 that includes a shroud portion 220. The shroud portion 220 defines openings 224 that communicate with the inner cavity 22 and open toward the cutting end 18. The shroud portion 220 is disposed adjacent to the cutting portion of the blade set 26. In one embodiment, as shown in FIG. 8, the electrode 58 of the ion emitting assembly 50 is angled towards the inboard side of the fixed blade 30. The ions emitted from the electrode 58 are utilized to charge the blade set for attraction of trimmed hairs 136 as discussed above with respect to the hair trimmer 100. In other embodiments, a plate electrode is placed adjacent the inboard side of the fixed blade 30 for attraction of trimmed hairs 136 toward the blade set 26. As operation of the hair trimmer continues 200, a build-up of trimmed hairs 128 may form. The hair trimmer 200 includes a suction fan 228 (schematically illustrated) that draws air in to the openings 224. To prevent the hairs 136 from collecting around the operating portions of the hair trimmer 200, a conduit 240 is formed in the cavity 22 for movement of the hairs 136. The conduit 240 communicates with the openings 224. The fan 228 moves air in through the openings 224, through the conduit 240, past the fan 228, and into a collection chamber 244. The air carries hairs 136 through the conduit 240 as is schematically illustrated in FIG. 8.

The collection chamber (schematically illustrated) includes a filter 248 (e.g., a screen) sized to retain the hairs 136 in the collection chamber until the hairs 136 are cleaned out. The collection chamber 244 is designed to be removed from the body portion 214 for emptying. The filter 248 also allows air to travel out of the collection chamber 244 and through air vents 252. The movement of air is represented in FIG. 8 with arrows. The fan 228 acts as a vacuum to remove excess hairs 136 from the blade set 26, thereby enhancing the reduction or elimination of the hairs 136 from falling on the floor or the person. The vacuum action may also directly remove hairs 136 as they are cut by the blade set 26.

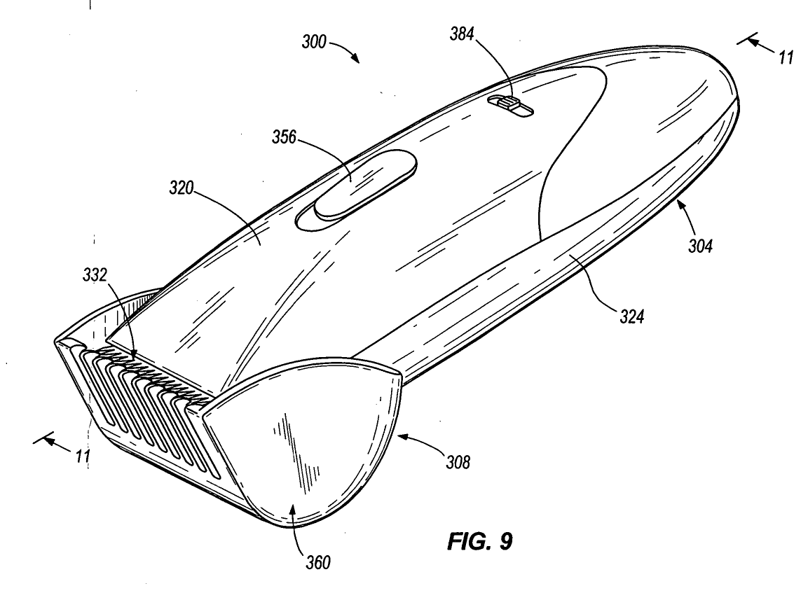

FIGS. 9-11 illustrate a hair trimmer 300. The hair trimmer 300 includes a hollow, elongated body portion 304 having a cutting end 308 and defining an inner cavity 312. The body portion 304 defines an opening 316 that communicates with the inner cavity 312 and opens toward the cutting end 308. The body portion 304 includes an upper housing 320 and a lower housing 324, and the lower housing 324 includes a shroud portion 328 that defines the opening 316 and is disposed adjacent a lower portion of a blade set 332.

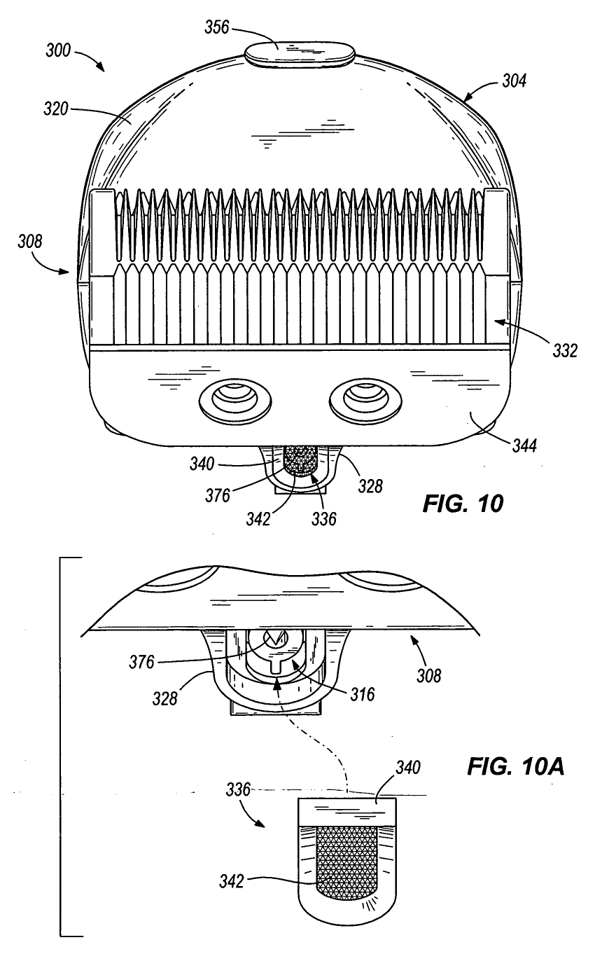

Referring to FIGS. 10 and 10A, the hair trimmer 300 includes a screen 336 generally positioned within the opening 316 of the body portion 304. The screen 336 includes a screen frame 340 that supports a mesh screen 342, although other known screens may be used. In the illustrated embodiment, the screen frame 340 is adhered to the shroud portion 328 of the trimmer 300 within the opening 316, however, in a further embodiment, the screen 336 may be coupled to the shroud portion 328 by way of a snap and lock mechanism, a slot within the shroud portion to slidingly receive the screen and hold the screen in place, or the like. The screen 336 protects the inner cavity 312 of the body portion 304 from the penetration of physical objects through the opening 316, as well as prevents hair from infiltrating the inner cavity 312. In a further embodiment, the hair trimmer 300 does not include a screen.

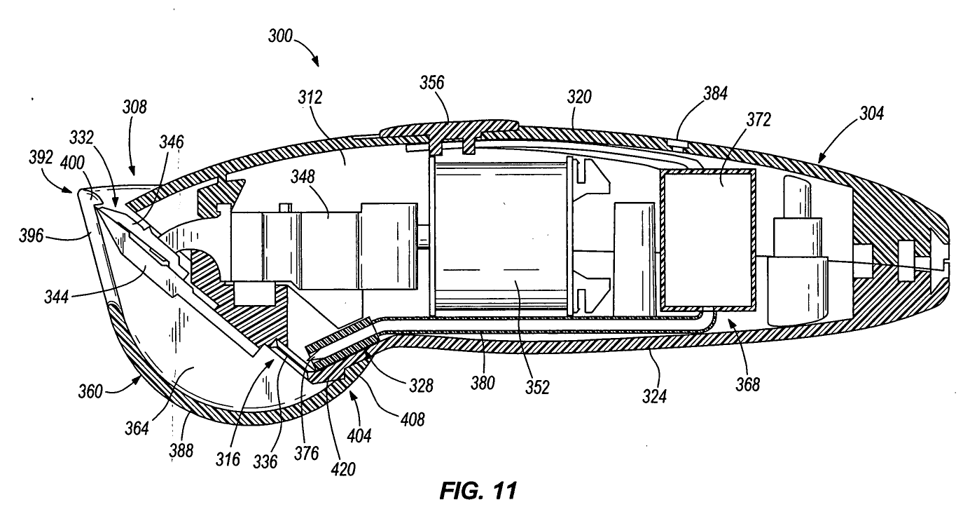

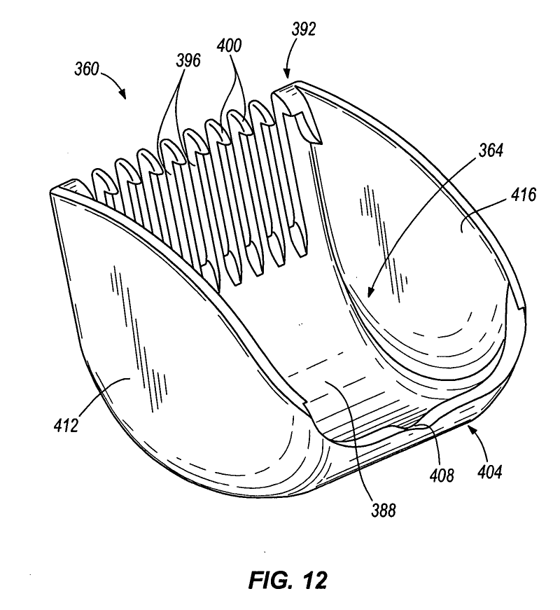

The body portion 304 supports the blade set 332 on the cutting end 308, similar to the blade set 26 discussed above with respect to trimmer 10 shown in FIG. 1. The blade set 332 includes a fixed blade 344 mounted to the body portion 304 and a reciprocating blade 346 biased against and moveable with respect to the fixed blade 344 by a drive mechanism 340 (FIG. 11). An electric motor 352 or actuator is mounted in the inner cavity 312 and is drivingly connected to the blade set 332 by the drive mechanism 348. A user actuates the motor 352 by using a power switch 356 provided on the body portion 304. The switch 356 is configured to interrupt the flow of electrical power from a power supply to the electric motor 352. The electrical power may include an alternating current (AC) or a direct current (DC) as described above with respect to the trimmer 10 shown in FIG. 1. As the hair trimmer 300 is guided through a person's hair, the reciprocating motion of the blade set 332 cuts the person's hair. A number of suitable blades sets, motors, and driving arrangements are known. It should be appreciated that hair trimmers having other types of blade sets, motors, and/or driving arrangements would be suitable for use in combination with the present invention.

Referring to FIGS. 9 and 11, a comb attachment 360 is coupled to the cutting end 308 of the body portion 304 such that the blade set 332 is disposed within the comb 360. The comb 360 defines a cavity 364 for receiving trimmed hairs as the blade set 332 cuts a person's hair. The comb is shown removed from the hair trimmer 300 in FIG. 12. The comb is positioned relative to the blade set 332 to control the length at which hair is cut. In the illustrated embodiment, the comb 360 is a one-piece part made of suitable molded plastic that is secured to the hair trimmer 300.

The hair trimmer 300 includes an ion emitting assembly 368 having an ionizer 372, an ion emitting electrode 376, and an ion lead 380 that electrically couples the ionizer 372 and the electrode 376. In some embodiments, as illustrated, the ionizer 372 is mounted in the inner cavity 312 and the electrode 376 is mounted near the cutting end 308 and the opening 316. In other embodiments, the components of the ion emitting assembly 368 may be alternatively positioned (e.g., the components, or portions thereof, may be mounted alternatively inside the inner cavity, outside the cavity, or a combination thereof). The electrode 376 of the ion emitter assembly 368 housed within the body portion 304 is angled towards the opening 316. The shroud portion 328 substantially surrounds the electrode 376 such that the ions emitted from the electrode 376 pass through the opening 316 and flow generally toward the cutting end 308.

For operation, the ionizer 372 receives an ionizer input power from a power source. In the illustrated embodiment, an ionizer switch 384 is provided on the body portion 304. The ionizer switch 384 is configured to interrupt the flow of electrical power (i.e., the ionizer input power) from the power supply to the ionizer 372. Utilization of a separate ionizer switch 384 allows a user to control the ion emitting assembly 368 independent of the motor 352. The ionizer switch 384 is a three-position switch that allows a user to select between an OFF position, a positive position such that the ionizer 372 emits positive ions, and a negative position such that the ionizer 372 emits negative ions. In a further embodiment, the ionizer switch 384 is a two-position on/off switch, or the ionizer input power may be provided to the ionizer 372 when the user actuates the power switch 356

The electrode 376 receives the ionizer output voltage from the ionizer 372 the ion lead 380 emits ions. The length of the ion lead 380 may vary based on the location of the electrode 376 with respect to the ionizer 372. In some embodiments, the need for the ion lead 380 be obviated. Although the illustrated electrode 376 is a needle electrode, other embodiments of the electrode may include alternative shapes (e.g., a plate electrode) and sizes.

The emitted ions have either a negative polarity or a positive polarity. In one embodiment of the hair trimmer 300 utilizing the screen 336, ions emitted from the electrode 376 are utilized to charge the screen 336 within the opening 316. The screen 336 is charged for attraction of trimmed hairs (not shown) toward the screen 336. As operation of the hair trimmer 300 continues, a build-up of trimmed hairs may form within the cavity 364 of the comb 360 as the hairs are drawn towards the screen 336. To empty the comb 360 of trimmed hairs, the comb is removed from the body portion 304 and emptied. In one embodiment, the screen 336 is made of an insulating material to reduce attraction of the trimmer hairs to the screen 336.

In another embodiment of the hair trimmer 300, with or without the screen, the ions emitted by the electrode 376 of the hair trimmer 300 are utilized to charge the comb 360 for attraction of the trimmed hairs. As the ions are emitted from the electrode 376, the emitted ions collect on the comb 360, thereby charging the comb 360. The charged comb 360 attracts objects with an opposite polarity (e.g., the hairs trimmed from a person's hair). As the hairs are trimmed, they are attracted to the comb 360, thereby reducing or eliminating hairs from falling on the floor or person. The degree of charge on the comb 360 may be controlled to optimize the amount of hair that is attracted. In other embodiments, the comb 360 is charged to a degree that repels hair from collecting on the comb 360, but does not interfere with the hair trimming process. As operation of the hair trimmer 300 continues a build-up of trimmed hairs forms within the cavity 364 of the comb 360. To empty the comb 360 of trimmed hairs, the comb 360 is removed from the body portion 304 and emptied. In another embodiment, ions emitted by the electrode 376 may substantially reduce or eliminate static electricity on a person's hair.

FIG. 12 illustrates the comb 360 removed from the hair trimmer 300. The comb 360 includes a generally curved portion 388 defining the concave cavity 364 and an outer wall of the comb 360. A first end 392 of the curved 388 portion includes a plurality of comb teeth 396 and each tooth 396 includes an extension 400 that protects a user from the blade set (as seen in FIG. 11). The extensions 400 also define a notch for receiving the fixed blade 344 and facilitating attachment of the comb 360 to the hair trimmer 300. A second end 404 of the curved portion 388 includes a notch 408 for facilitating coupling of the comb 360 to the hair trimmer 300. The comb includes two side walls 412, 416 extending between the first end 400 and the second end 404 of the curved portion 388. The side walls 412, 416 define the cavity 364 of the comb 360.

Referring to FIGS. 10 and 11, the shroud portion 328 of the hair trimmer 300 includes a downwardly extending hook 420 rearward of the opening 316. To couple the comb 360 to the hair trimmer 300, the notch defined by the comb extensions 400 is placed over an outer edge of the fixed blade 344. Next, the second end 404 of the comb 360 is stretched and/or pulled over the hook 420 on the body portion 404 such that the notch 408 and the hook 420 interlock. The interlocks between comb extensions 400 and the fixed blade 344 and the notch 408 and the hook 420 secure the comb 360 to the body portion 404. When the comb 360 is coupled to the hair trimmer 300, the blade set 322 is housed within the cavity 364. To gain access to the comb cavity 364, the comb 360 is removed from the hair trimmer 300. In a further embodiment, the comb is adjustable to vary a cut length of the blade set 322.

Other embodiments of the invention may utilize combinations of the above embodiments. Still other embodiments of the invention may utilize ions emitted from the electrode 58 for other hair care purposes.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

What is claimed is:

1. A hair trimmer comprising:
a body portion having a cutting end, the body portion defining a cavity and an opening communicating with the cavity, wherein the opening is separate from the cutting end;
a blade set mounted adjacent the cutting end;
a comb coupled to the cutting end of the body portion wherein the blade set is at least partially disposed within the comb; and
an ion emitter assembly at least partially mounted within the cavity, wherein ions emitted from the ion emitter assembly flow through the opening and toward the cutting end and the comb.

2. The hair trimmer of claim 1 wherein the comb is removable from the body portion.

3. The hair trimmer of claim 1 wherein the comb comprises a curved body portion having a first end configured for coupling to the blade set and a second end configured for coupling to the body portion, a pair of side walls extend between the first and second ends to define a cavity for housing the blade set.

4. The hair trimmer of claim 3 wherein trimmed hairs are collected in the comb cavity.

5. The hair trimmer of claim 1 wherein the comb is positioned to cover the opening.

6. The hair trimmer of 1 wherein the ion emitter assembly includes
an ionizer adapted to receive an input power and generate an output power based at least in part on the input power; and
an electrode adapted to receive the output power from the ionizer and emit ions.

7. The hair trimmer of claim 1 wherein the body portion includes an upper portion and a lower portion, the opening being defined in the lower portion.

8. The hair trimmer of claim 7 wherein the lower portion includes a shroud portion protruding from the body portion and defining the opening.

9. The hair trimmer of claim 1, and further comprising a screen positioned within the opening.

10. The hair trimmer of claim 9 wherein the ion emitting assembly charges the screen to attract trimmed hair to the screen.

11. The hair trimmer of claim 1 wherein the ion emitting assembly charges the comb for attraction of trimmed hairs to the comb.

12. The hair trimmer of claim 1, and further comprising a first switch for selecting an on/off state of the hair trimmer and a second switch for controlling an on/off state of the ion emitter assembly.

13. The hair trimmer of claim 1 wherein polarity of the ions emitted from the ion emitter assembly is user selectable via a polarity switch.

14. A hair trimmer configured to trim hair and reduce a static charge of the hair as the hair is trimmed, the hair trimmer comprising:
a body portion having a cutting end, the body portion defining an inner cavity and an opening communicating with the cavity, wherein the opening is separate from the cutting end and faces generally toward the cutting end;
a blade set mounted adjacent the cutting end;
a comb coupled to the cutting end of the body portion wherein the blade set is at least partially disposed within the comb; and
an ion emitting assembly at least partially mounted within the inner cavity and including an ionizer adapted to receive an ionizer input power and an electrode positioned adjacent the opening, the electrode electrically coupled to and adapted to receive an output power from the ionizer to emit ions, wherein ions emitted from the electrode pass through the opening and toward the cutting end and the comb.

15. The hair trimmer of claim 14 wherein the comb is removable from the body portion.

16. The hair trimmer of claim 14 wherein the comb comprises a curved body portion having a first end configured for coupling to the blade set and a second end configured for coupling to the body portion, a pair of side walls extend between the first and second ends to define a cavity for housing the blade set.

17. The hair trimmer of claim 16 wherein trimmer hairs are collected in the comb cavity.

18. The hair trimmer of claim 14 wherein the comb is positioned to cover the opening.

19. The hair trimmer of claim 14 wherein the body portion includes an upper portion and a lower portion, the opening being defined in the lower portion.

20. The hair trimmer of claim 19 wherein the lower portion includes a shroud portion protruding from the body portion and defining the opening.

21. The hair trimmer of claim 14, and further comprising a screen positioned within the opening.

22. The hair trimmer of claim 21 wherein the ion emitting assembly charges the screen to attract trimmed hair to the screen.

23. The hair trimmer of claim 14 wherein the ion emitting assembly charges the comb for attraction of trimmed hairs to the comb.

24. The hair trimmer of claim 14, and further comprising a first switch for selecting an on/off state of the hair trimmer and a second switch for controlling an on/off state of the ion emitter assembly.

25. The hair trimmer of claim 14 wherein polarity of the ions emitted from the ion emitter assembly is user selectable via a polarity switch.
